(19) United States
(12) Patent Application Publication
(10) Pub. No.: US 2007/0247874 A1
(43) Pub. Date: Oct. 25, 2007

(54) LAMP BULB ASSEMBLY

(76) Inventor: Shi-Jun Yang, Hui Dong City (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,678

(22) Filed: Apr. 21, 2006

(51) Int. Cl. H01R 33/00

(52) U.S. Cl. 362/654; 362/249

(57) ABSTRACT

A lamp bulb assembly having a light bulb unit and a socket is provided. The light bulb unit includes a light bulb holder and a light bulb. The light bulb holder includes a male fastening member. The male fastening member is made of one or more U-shaped tongues, each with an engaging element. The socket further includes a plurality of conductive leads, a body, and a female fastening member for receiving the male fastening member. The U-shaped tongue of the light bulb unit is inserted in a hollow recess of the socket. The U-shaped tongue allows for the bending inward to disconnect the engaging element from the hollow recess for easy separation of the light bulb unit from the socket. The U-shaped tongue allows for using the naked fingers for separation during changing of the light bulbs without requiring the use of any tools.

### BACKGROUND OF THE INVENTION

1. Field of Invention

The present invention relates to a new lamp bulb assembly, and in particular, to a light bulb unit and a socket for a lamp bulb assembly for use in decorative light string.

2. Description of Related Art

Decorative strings of multicolored lights are widely used around the globe for decoration purposes during festive occasions. They may be used as decorations on buildings or various structures, but are most often seen on Christmas trees. Although many new designs for filaments and sockets used in the strings as well as automatic assembling apparatus have been developed, an effective and secure snap construction for a lamp bulb assembly for securing the light bulb unit into the socket has yet to be successfully developed.

For example, as shown in FIG. 1, a conventional ornamental lamp bulb assembly 50 consisting of a light bulb unit 20 and a socket 10 in a light bulb string for a Christmas tree is described. The above conventional ornamental lamp bulb assembly 50 has the socket 10 formed with a hole 14, a bulb 28 having a lighting element, and an insert 26 having two electrical leads 25 which are mounted on two sides of the insert 26. The conventional light bulb unit 20 has two T-shaped tongues 11, in which each of the T-shaped tongues 11 has a shoulder 111. The socket 10 has two flexible receiving means 30 comprising of two opposite L-shaped protrusions 32 which together form a compartment 34, and two paths 36. The conventional ornamental lamp bulb assembly 50 is prone to accidental and/or unintentional disengagement of the light bulb unit 20 from the socket 10. Furthermore, the force required for disengagement of the conventional ornamental lamb bulb assembly 50 requires only to be of a single direction at a minimum. There are also tremendous amount of flexibility permitted in the direction of the applied force for the disengagement of the conventional ornamental lamp bulb assembly 50; as a result, it is relatively easy to be separated during normal use. Furthermore, the amount of force required for disengagement of the conventional ornamental lamp bulb assembly 50 is also relatively low. Based upon the above described disadvantages, an improved design for a lamp bulb assembly is indeed needed.

### SUMMARY OF THE INVENTION

An objective of the invention is to provide a new lamp bulb assembly, in which a bulb holder has a more secure and firmer connection with the socket and at the same time can be separated from the same relatively easily if required.

A light bulb holder with improved fastening mechanism for allowing the bulb to be fastened to the socket firmly but yet can be separated easily if required is provided.

According to an embodiment of the invention, a lamp includes a light bulb unit and a socket. The light bulb unit includes a light bulb holder and a light bulb. The light bulb holder has a male fastening member. The male fastening member is made of a U-shaped tongue with an engaging element. The socket further includes a plurality of conductive leads, a body, and a female fastening member for receiving the male fastening member of the light bulb holder. The U-shaped tongue of the light bulb unit is inserted in a hollow recess of the socket. The engagement element disposed at the sides of the U-shaped tongue is of a raised beveled slanted edge design which provides a smoother and lower resistance motion in one direction as well as adequate interference against the sides of the female fastening member when moved in the opposite direction, thus allowing the male fastening member to be securely attached to the female fastening member during normal use. The U-shaped tongue allows for the bending inward for disconnecting the engaging element from the hollow recess for easy separation of the light bulb unit from the socket. The U-shaped tongue allows for using the naked fingers for separation during changing of the light bulbs for the lamp without requiring the use of any tools. In addition, the light bulb unit and the socket of the lamp bulb assembly require the pressing of two fingers simultaneously for physically separating the light bulb unit and the socket.

In order to easily understand the invention, the characteristics, advantages and other purposes, an example with Figures are shown in the following.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded perspective view of a conventional ornamental lamp bulb assembly for use in decorative light string.

FIG. 2 is an exploded perspective view of a lamp bulb assembly for decorative light string, according to a first embodiment of the present invention.

FIG. 3A is a perspective view of a light bulb holder for a light bulb unit, according to the first embodiment of the present invention.

FIG. 3B is a front cross-sectional view of the light bulb holder for the light bulb unit, according to the first embodiment of the present invention.

FIG. 4A is a perspective view of a socket with a female fastening member for a light bulb unit, according to the first embodiment of the present invention.

FIG. 4B is a top view of the socket with the female fastening member for the light bulb unit, according to the first embodiment of the present invention.

FIG. 4C is a front cross-sectional view of the socket with the female fastening member for the light bulb unit, according to the first embodiment of the present invention.

FIG. 5 is an exploded perspective view of a lamp bulb assembly for use in decorative light string, according to a second embodiment of the present invention.

FIG. 6 is a perspective view of a socket with a female fastening member for a light bulb unit, according to the second embodiment of the present invention.

FIG. 7 is a front cross-sectional view of the socket with the female fastening member for the light bulb unit, according to the second embodiment of the present invention.

FIG. 8 is an exploded perspective view of a lamp bulb assembly for use in decorative light string, according to a third embodiment of the present invention.

FIG. 9 is a perspective view of an engagement portion for a light bulb holder for a light bulb unit, according to the third embodiment of the present invention.

FIG. 10 is a perspective view of a receiving portion for a light bulb holder for the light bulb unit, according to the third embodiment of the present invention.

FIG. 11 is a perspective view of a socket with a female fastening member for a light bulb unit, according to the third embodiment of the present invention.

FIG. 12 is an exploded perspective view of al lamp bulb assembly for use in decorative light string, according to a fourth embodiment of the present invention.

FIG. 13 is a perspective view of a light bulb holder with two male fastening members for a light bulb unit, according to the fourth embodiment of the present invention.

FIG. 14 is a perspective view of a socket with two female fastening members for a light bulb unit, according to the fourth embodiment of the present invention.

FIG. 15 is an exploded perspective view of a lamp bulb assembly for use in decorative light string, according to a fifth embodiment of the present invention.

FIG. 16 is a perspective view of an engagement portion for a light bulb holder for a light bulb unit, according to the fifth embodiment of the present invention.

FIG. 17 is a perspective view of a receiving portion for a light bulb holder for the light bulb unit, according to the fifth embodiment of the present invention.

FIG. 18 is a perspective view of a socket with two female fastening members for the light bulb unit, according to the fifth embodiment of the present invention.

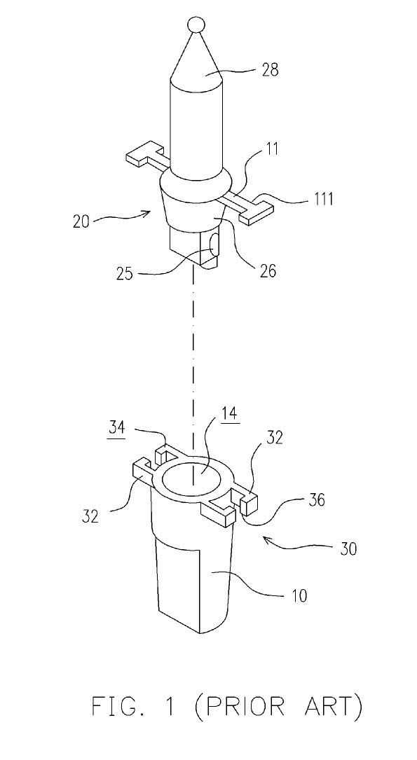

### DESCRIPTION OF THE EMBODIMENTS

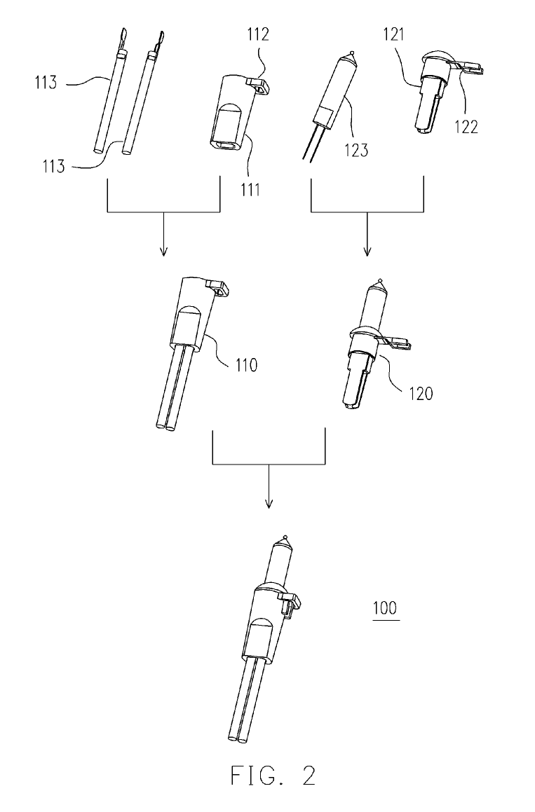

Referring to FIG. 2, a lamp bulb assembly 100 for use in decorative light string including a light bulb unit 120 and a socket 110 is shown, according to a first embodiment of the present invention. The light bulb unit 120 has a light bulb holder 121 and a light bulb 123. Furthermore, the light bulb holder 121 includes a male fastening member 122. Furthermore, the lamp bulb assembly 100 also includes the socket 110 with a female fastening member 112 for the light bulb unit 120, according to the first embodiment of the present invention. The socket 110 further includes a plurality of conductive leads 113, a body 111, and the female fastening member 112 is for receiving the male fastening member 122 of the light bulb holder 121.

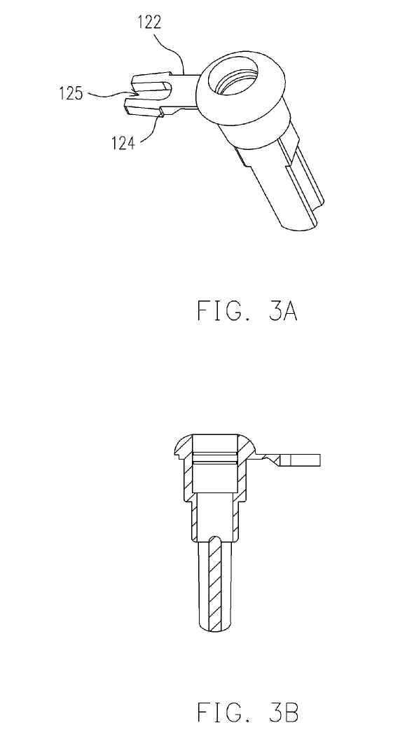

Referring to FIGS. 3A-3B, a light bulb holder 121 for a light bulb unit 120, according to the first embodiment of the present invention, is shown. The light bulb holder 121 has a male fastening member 122. The male fastening member 122 is formed of a U-shaped tongue 125 with an engaging element 124.

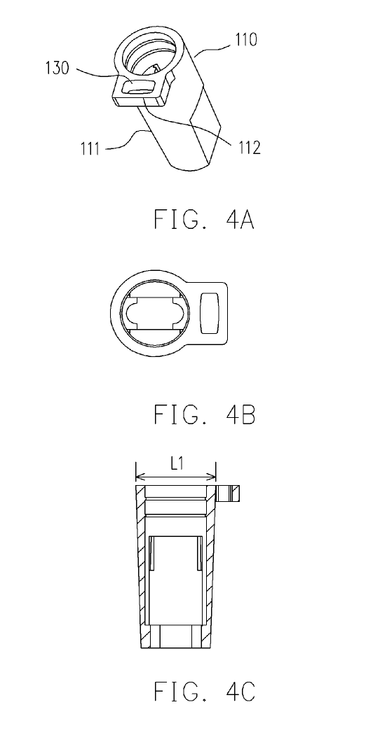

Referring to FIGS. 4A-4C, a socket 110 with a female fastening member 112 to be used with a light bulb unit 120 is shown, according to the first embodiment of the present invention. According to FIG. 2, the socket 110 further includes a plurality of conductive leads 113, a body 111, and a female fastening member 112 for receiving the male fastening member 122 of the light bulb holder 121. The body 111 of the socket 110 has a length L1 as shown in FIG. 4C.

According to the first embodiment of the present invention, the method of assembly of the lamp bulb assembly 100 first requires the U-shaped tongue 125 of the light bulb unit 120 to be inserted in a hollow recess 130 of the socket 110. The engagement element 124 disposed at the sides of the U-shaped tongue 125 is of a raised beveled slanted-edge design which provides a smoother and lower resistance motion when moved in one direction as well as adequate interference against the sides of the female fastening member 112 when moved in the opposite direction, thus allowing the male fastening member 122 to be securely attached to the female fastening member 112. The U-shaped tongue 125 allows for the bending inward to disconnect the engaging element 124 from the hollow recess 130 for easy separation of the light bulb unit 120 from the socket 110. The U-shaped tongue 125 allows for separation using a plurality of naked fingers during changing of the light bulbs 123 without requiring the use of any tools. The light bulb unit 120 and the socket 110 according to the first embodiment of the invention are tested to withstand a separating force of at least 20 newtons before the light bulb unit 120 and the socket 110 are physically separated. In addition, the light bulb unit 120 and the socket 110 of the lamp bulb assembly 100 require the pressing of two fingers simultaneously for physically separating the light bulb unit 120 and the socket 110.

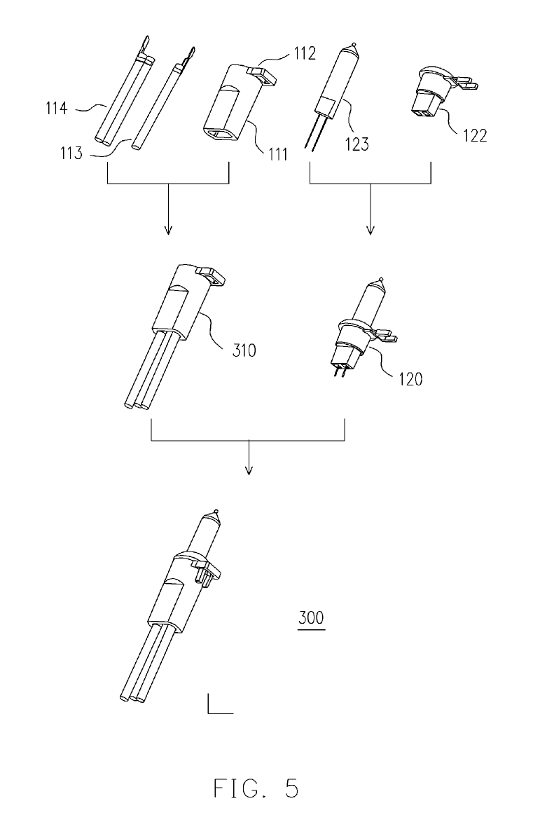

Referring to FIG. 5, a lamp bulb assembly 300 for use in decorative light string includes a light bulb unit 120 and a socket 310, according to a second embodiment of the present invention, is shown.

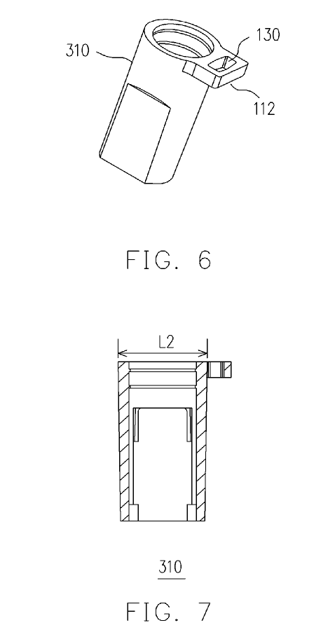

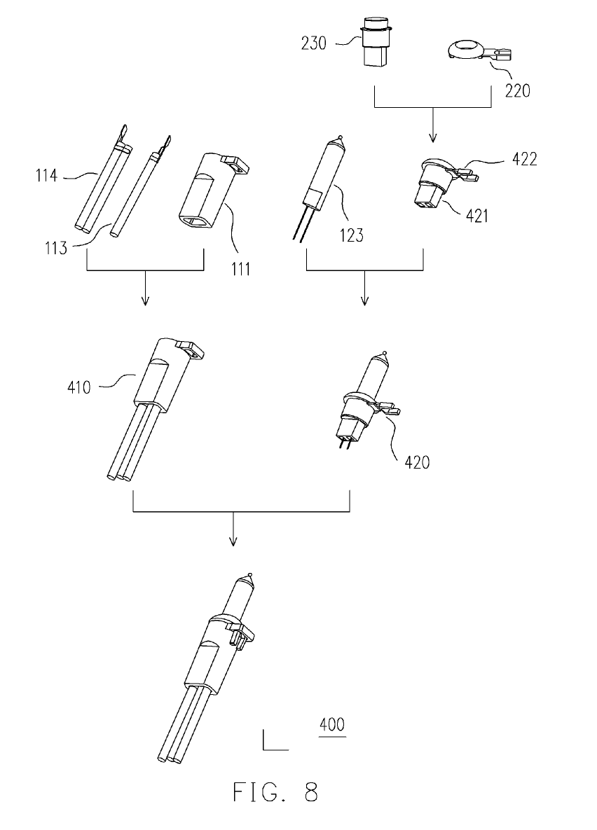

Referring to FIGS. 6 and 7, a socket 310 according to the second embodiment of the present invention has a length L2 for the socket 310 that is longer than the length L1 shown in FIG. 4C for the socket 110.

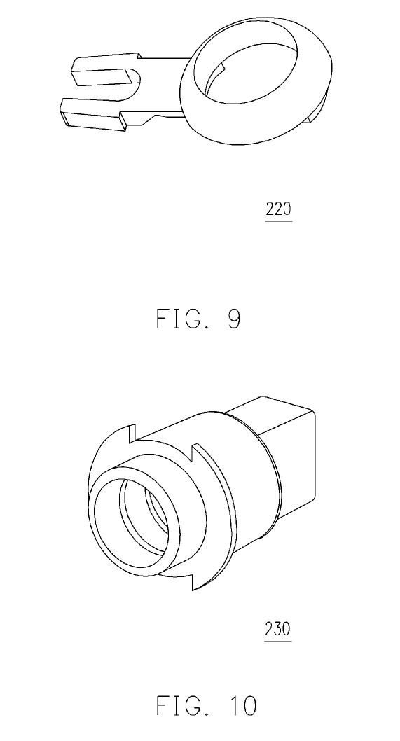

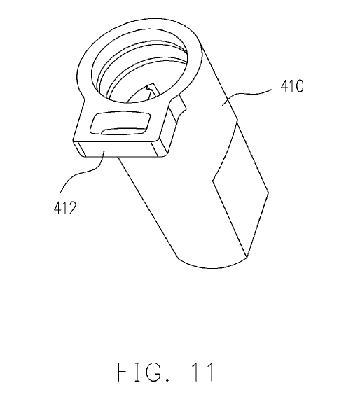

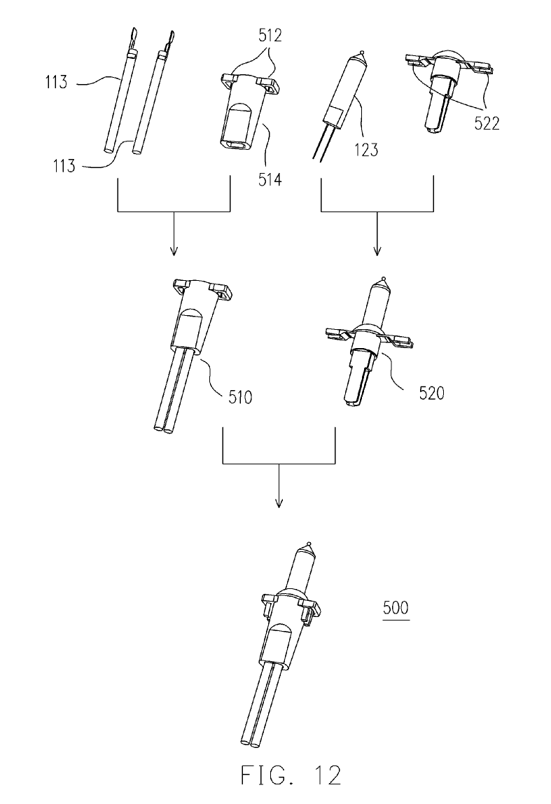

Referring to FIG. 8, a lamp bulb assembly 400 for use in decorative light string includes a light bulb unit 420 and a socket 410, according to a third embodiment of the present invention, is shown. The light bulb unit 420 according to the third embodiment of the present invention includes a light bulb holder 421 which has a male fastening member 422. The male fastening member 422 according to the third embodiment of the present invention has an engagement portion 220 that is detachable from a receiving portion 230. The engagement portion 220 is inserted into the receiving portion 230 to form the light bulb holder 421 according to the third embodiment of the present invention as shown in FIG. 8. The engagement portion 220 for the light bulb holder 421 according to the third embodiment of the present invention is further shown in FIG. 9. The receiving portion 230 for the light bulb holder 421 according to the third embodiment of the present invention is further shown in FIG. 10. In addition, the socket 410 with a female fastening member 412 to be used with the light bulb unit 420, according to the third embodiment of the present invention, is shown in FIG. 11.

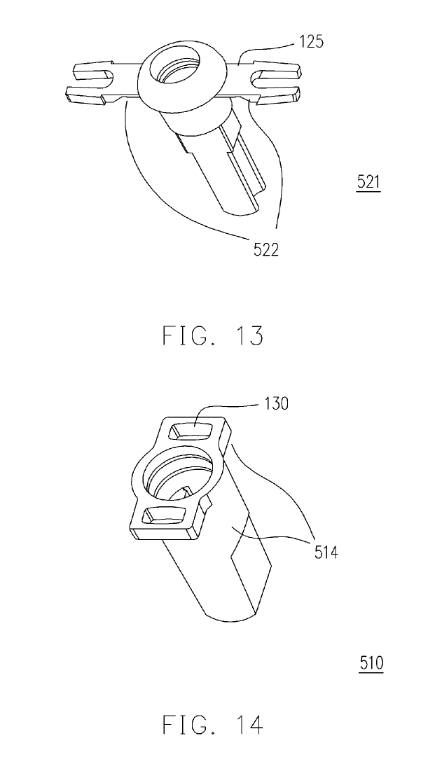

Referring to FIG. 12, a lamp bulb assembly 500 for decorative light string includes a light bulb unit 520 and a socket 510, according to a fourth embodiment of the present invention, is shown. The light bulb unit 520 includes a light bulb holder 521 and a light bulb 123. Referring to FIG. 13, furthermore, the light bulb holder 521 includes two male fastening members 522. According to FIG. 14, the lamp bulb assembly 500 also includes the socket 510 with two female fastening members 512, according to the fourth embodiment of the present invention. The socket 510 further includes a plurality of conductive leads 113, a body 514, and each of the female fastening members 512 for receiving each of the male fastening members 522 as shown in FIG. 12.

According to the fourth embodiment of the present invention, the method of assembly of the lamp bulb assembly 500 first requires two U-shaped tongues 125 of the light bulb unit 520 to be inserted in two hollow recesses 130 of the socket 510. The engagement element 124 disposed at the sides of each of the U-shaped tongues 125 is of a raised beveled slanted-edge design which provides a smoother and lower resistance motion when moved in one direction as well as adequate interference against the sides of the female fastening member 512 when moved in the opposite direction, thus allowing the male fastening member 522 to be securely attached to the female fastening member 512. The two U-shaped tongues 125 allows for the bending inward to disconnect the two engaging elements 124 from the hollow recesses 130 for easy separation of the light bulb unit 520 from the socket 510. The two U-shaped tongues 125 allow for using naked fingers for separation during changing of the light bulbs 123 without requiring the use of any tools. The light bulb unit 520 and the socket 510 according to the first embodiment of the invention are tested to withstand a separating force of at least 40 newtons before the light bulb unit 520 and the socket 510 are physically separated. In addition, the light bulb unit 520 and the socket 510 of the lamp bulb assembly 500 require the pressing of two fingers simultaneously for physically separating the light bulb unit 520 and the socket 510.

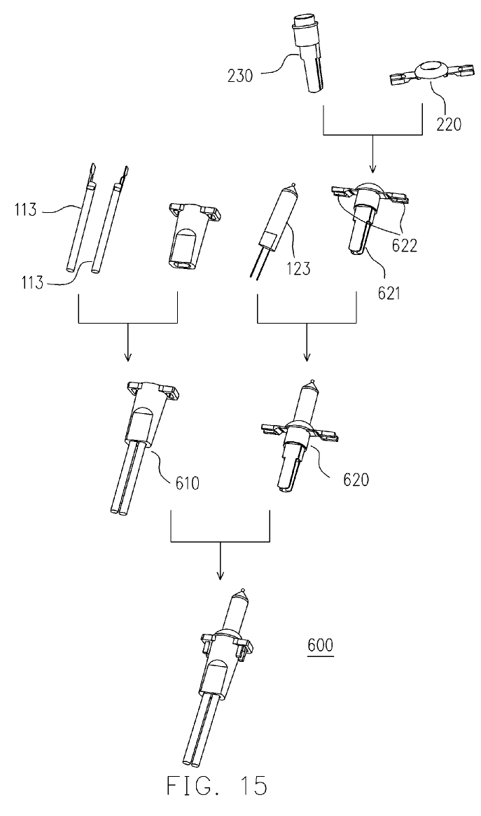

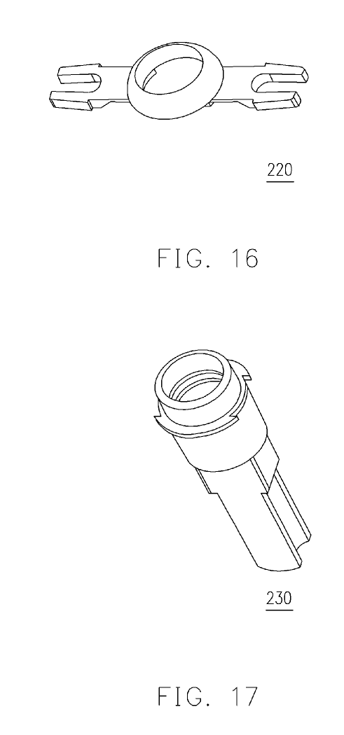

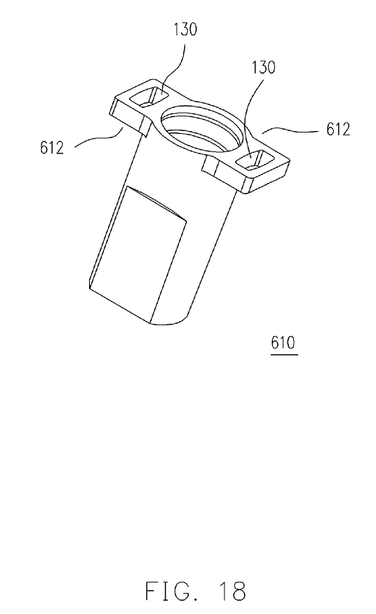

Referring to FIG. 15, an lamp bulb assembly 600 for use in decorative light string includes a light bulb unit 620 and a socket 610, according to a fifth embodiment of the present invention, is shown. The light bulb unit 620 according to the fifth embodiment of the present invention includes a light bulb holder 621 includes two male fastening members 622. The engagement portion 220 according to the fifth embodiment of the present invention is detachable from the receiving portion 230. The engagement portion 220 is inserted into the receiving portion 230 to form two male fastening members 622 as well as the light bulb holder 621 according to the fifth embodiment of the present invention as shown in FIG. 15. The engagement portion 220 for the light bulb holder 621 according to the fifth embodiment of the present invention is further shown in FIG. 16. The receiving portion 230 for the light bulb holder 621 according to the fifth embodiment of the present invention is further shown in FIG. 17. In addition, the socket 610 with the two female fastening members 612 for a light bulb unit 620, according to the fifth embodiment of the present invention, is shown in FIG. 18.

According to the fifth embodiment of the present invention, the method of assembly of the lamp bulb assembly 600 first requires the two U-shaped tongues 125 of the light bulb unit 620 to be inserted in two hollow recesses 130 of the socket 610. The two U-shaped tongues 125 allows for the bending inward to disconnect the two engaging elements 124 from the hollow recesses 130 for the easy separation of the light bulb unit 620 from the socket 610. The two U-shaped tongues 125 allow for use of the naked fingers for separation during changing of the light bulbs 123 without requiring the use of any tools. In addition, the light bulb unit 620 and the socket 610 of the lamp bulb assembly 600 require the pressing of two fingers simultaneously for physically separating the light bulb unit 620 and the socket 610.

This invention offers several advantages over the prior art including but not limited to the following: 1) reduced risk of accidental and/or unintentional disengagement of the lamp bulb assembly; 2) the requiring of disengagement force of the light bulb assembly to be in at least two specific directions in the form of two fingers pressing simultaneously on the U-shaped tongue for physically separating the light bulb unit and the socket; and 3) higher force required for disengagement of the lamp bulb assembly during normal use.

Although several embodiments have been mentioned above to explain this invention, it does not limit to this invention. It will be apparent to those skilled in the art that various modifications and variations can be made to the structure of the present invention without departing from the scope or spirit of it. In view of the foregoing, it is intended that the present invention cover modifications and variations of this invention provided they fall within the scope of the following claims and their equivalents.

What is claimed is:

1. An ornamental lamp bulb assembly, comprising:
a socket, wherein the socket comprising of a plurality of conductive leads, a female fastening member disposed on one side of the opening of the socket, and a body; and
a light bulb unit, wherein the light bulb unit comprising of a light bulb holder and a light bulb, the light bulb holder comprising of a male fastening member disposed near the opening of the light bulb holder used for the insertion of the light bulb, the female fastening member of the socket is for receiving the male fastening member of the light bulb unit, the male fastening member has a U-shaped tongue with an engaging element, and the light bulb unit and the socket require the application of force in least two specific directions on the U-shaped tongue simultaneously for physically separating the light bulb unit and the socket.

2. The lamp bulb assembly as claimed in claim 1, wherein the male fastening member of the light bulb holder further comprising:
an engagement portion and a receiving portion, wherein the engagement portion is detachable from the receiving portion.

3. The lamp bulb assembly as claimed in claim 1, wherein the light bulb unit and the socket withstand a separating force of at least 20 newtons before the light bulb unit and the socket are physically separated.

4. The ornamental lamp bulb assembly as claimed in claim 1, wherein the application of force in least two specific directions for physically separating the light bulb unit and the socket is in the form of the pressing of two fingers simultaneously on the U-shaped tongue.

5. The lamp bulb assembly as claimed in claim 1, wherein the socket further comprising:
a slot, disposed at one side of the socket, extending through the socket; and
the length of the socket elongated for accommodating the slot.

6. The lamp bulb assembly as claimed in claim 1, wherein the male fastening member of the light bulb holder further comprising:
an engagement portion and a receiving portion, wherein the engagement portion is detachable from the receiving portion.

7. A lamp bulb assembly, comprising:
a socket, wherein the socket comprising of a plurality of conductive leads, two female fastening members disposed on two sides of the opening of the socket, and a body; and
a light bulb unit, wherein the light bulb unit comprising of a light bulb holder and a light bulb, the light bulb holder comprising of two male fastening members disposed near the opening of the light bulb holder used for the insertion of the light bulb, the two female fastening members are for receiving the two male fastening members, each of the male fastening member is made of a U-shaped tongue, each with an engaging element, and the light bulb unit and the socket require the application of force in least two specific directions simultaneously on the U-shaped tongue for physically separating the light bulb unit and the socket.

8. The lamp bulb assembly as claimed in claim 7, wherein the male fastening member of the light bulb holder further comprising:
an engagement portion and a receiving portion, wherein the engagement portion is detachable from the receiving portion.

9. The ornamental lamp bulb assembly as claimed in claim 7, wherein the application of force in least two specific directions for physically separating the light bulb unit and the socket is in the form of the pressing of two fingers simultaneously on the U-shaped tongue.

10. The lamp bulb assembly as claimed in claim 7, wherein the light bulb unit and the socket withstand a separating force of at least 40 newtons before the light bulb unit and the socket are physically separated.
